(19) United States
(12) Patent Application Publication
(10) Pub. No.: US 2007/0256461 A1
(43) Pub. Date: Nov. 8, 2007

(54) Light weight hinged handcuff with powdered metal hinge

(76) Inventors: Kevin L. Parsons, Appleton, WI (US); Todd Bequette, Janesville, WI (US)

Correspondence Address: Welsh & Katz, Ltd.;Jon P. Christensen, 22nd Floor, 120 South Riverside Plaza, Chicago, IL, 60606, US

(21) Appl. No.: 11/429,790

(22) Filed: May 8, 2006

(51) Int. Cl. E05B 75/00

(52) U.S. Cl. 70/16

(57) ABSTRACT

A handcuff assembly is provided that includes a pair of handcuffs and a connector link assembly that joins the pair of handcuffs. The connector link assembly includes a molded, generally flat base link. The base link has a first thickness on a first end, a step on a first side of the base link from the first thickness to a second, relatively greater thickness on a second, opposing end, and an aperture extending through the thickness of the second end. The base link also has a post disposed on the first side and extending from the first end parallel to the aperture.

### BACKGROUND OF THE INVENTION

1. Field of the Invention

The present invention relates to an improved set of handcuffs having a number of features, which facilitate their use. These features include, for example, a lightweight, yet durable and strong connecting hinge made of a powdered metal that facilitates placing the handcuffs over an officer's belt, a slightly larger bow for engaging a wrist of a person to be restrained, a rounded inner surface of the bow and cooperating arcuate cheek arms, cheek arms formed from a metal plate and having reinforcing ribs, a molded polymer covering surrounding the cheek arms and providing a rounded surface on the inner edge of the cheek arms which engage a wrist of a prisoner, interlocking tabs on the folded cheek arm forming plates, the folded cheek-arm forming plates which are covered by the polymer molding providing a non-riveted base frame and cheek arms.

2. Description of the Related Art

Heretofore, a large number of handcuffs have been proposed. Several prior art U.S. patents disclosing previously proposed handcuffs and features thereof are set forth in the analogous and non-analogous U.S. patents listed below:

| U.S. PAT. NO. | PATENTEE |
|---|---|
| 4,314,466 | Harris |
| 4,574,600 | Moffett |
| 5,660,064 | Ecker et al. |
| 6,574,998 | Kwon |
| 6,672,116 | Hilliard |

Prior art handcuffs are typically known to be heavy and include a cheek plate assembly made of metal plates which are cut to a desired shape and riveted together such that rivet heads protrude from the sides of the cheek assembly.

In view of the rivet heads protruding form the cheek plate assembly, it is hard to align the cuffs and to fold the cuffs flat.

Also, in many designs of prior art handcuffs, a set of connecting links are provided for connecting one handcuff to another handcuff. In one particular design, the connecting links are made up of a combination of flat plates that limit the movement of a prisoner. The connecting links are limited in number and often do not allow the handcuffs to be folded flat or folded over a belt.

Often times, the cheek plates and/or the bow of the handcuff have edges along the inside of the curved surface of the bow or cheek plates which can cause trauma or injury to a wrist.

Also, the curved envelope of the bow and the curved envelope of the cheek plates in conventional handcuffs often do not properly fit many wrists and sometimes are not large enough or small enough.

As will be described in greater detail hereinafter, the handcuffs of the present invention have high strength and are relatively light weight. The bow is preferably made of sintered metal powder with rounded inner edges and an outer flat contact surface. It is preferably polymer infused to prevent corrosion and absorption of body fluids, e.g., sweat.

The connecting links between handcuffs is also made of a powdered metal. A unique design of a base link of the connecting links reduces parts count. Metal injection molding may be used to fabricate the base link to very close dimensions at a very low cost.

Strength of the bow and cheek plates and connecting links is maximized by the selection of an optimal combination of materials and heat treatment of the materials as well as design of frame geometry and provision of reinforcing ribs. Also, the use of a die stamped metal plate facilitates forming of a base frame and cheek plate arms of a unitized cheek plate assembly.

Furthermore, the use of a polymer overmold over the cheek plate frame produces a pair of a handcuff with rounded edges, beveled lock slots and beveled keyways. Additionally the polymer can be color coded to indicate the source of the handcuffs.

### BRIEF SUMMARY OF THE INVENTION

According to one of the teachings of the present invention, a handcuff assembly is provided that includes a pair of handcuffs and a connector link assembly that joins the pair of handcuffs. The connector link assembly includes a molded, generally flat base link. The base link has a first thickness on a first end, a step on a first side of the base link from the first thickness to a second, relatively greater thickness on a second, opposing end, and an aperture extending through the thickness of the second end. The base link also has a post disposed on the first side and extending from the first end parallel to the aperture.

### BRIEF DESCRIPTION OF THE SEVERAL VIEWS OF THE DRAWINGS

FIG. 1 is a plan view of a pair of handcuffs constructed according to the teachings of the present invention.

FIG. 2 is a plan view of a punched plate, which is folded over to create a pair of cheek plates.

FIG. 3 is a side, top and end view of a connector link insert shown in FIG. 1.

FIG. 4 is a perspective view of the punched plate shown in FIG. 2 folded over and molded to form a unitized steel frame including the base frame portion and the cheek plates with the connector links mounted in the base frame portion.

FIG. 5 is an end view of the unitized steel frame and shows the frame interlock in the base frame portion.

FIG. 6 is a perspective exploded view of one handcuff showing an open position of the bow relative to the encapsulated unitized steel frame and shows an exploded view of a rivet for connecting the bow to the pair of cheek plates and an exploded view of two (2) connector links mounted to the base frame;

FIG. 7 is a is a sectional view of the completed rivet after swaging;

FIG. 8 is a plan view of the bow mounted to the cheek plates prior to encapsulation of the unitized steel frame and shows a detent formed in one (1) side of the base frame portion received in a track groove in the tooth track portion.

FIG. 9 is a sectional view through the handcuff shown in FIG. 8, taken along line 9-9 of FIG. 8 and shows detents in each plate of the base frame portion received in track grooves in each side of the tooth track portion of the bow;

FIG. 10 is a perspective view of the bow mounted to the cheek plates prior to encapsulation of the unitized steel frame and shows the tip of the bow and tooth track portion prior to engaging with the detents in the plates of the base frame portion;

FIG. 11 is an enlarged view of the portions broken away (of the bow mounted to the cheek plates) prior to encapsulation of the unitized steel frame and shows the tip of the bow and tooth track portion prior to engaging with the detents in the plates of the base frame portion;

FIG. 12 is a side perspective view of the connector link assemblies of FIG. 1; and

FIG. 13 is an exploded view of the connector link assemblies of FIG. 1.

### DETAILED DESCRIPTION OF THE INVENTION

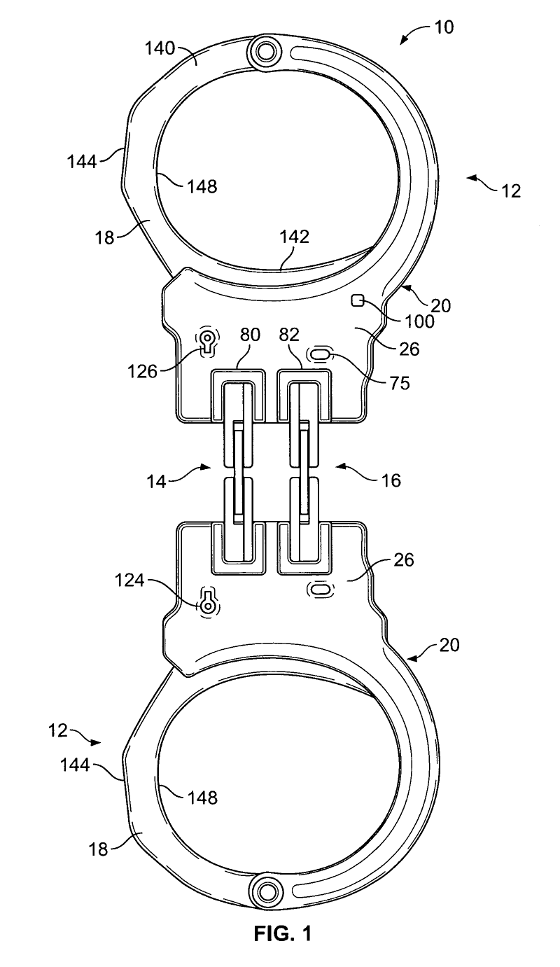

Referring now to the drawings in greater detail, there is illustrated in FIG. 1 a set of handcuffs 10 including two handcuffs 12 linked together by two compound hinge sets (connector link assemblies) 14 and 16. Each cuff 12 comprises a bow 18, pivotally connected to a molded cheek plate assembly 20.

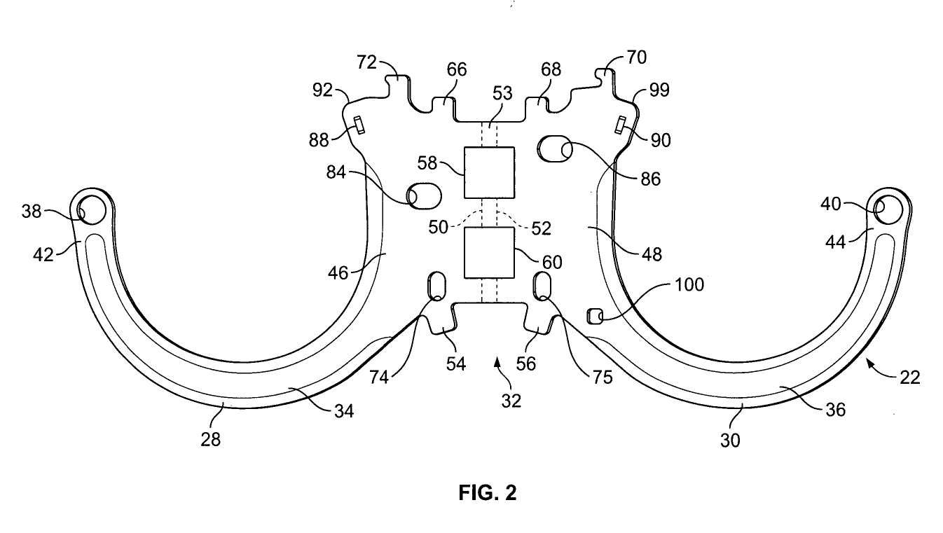

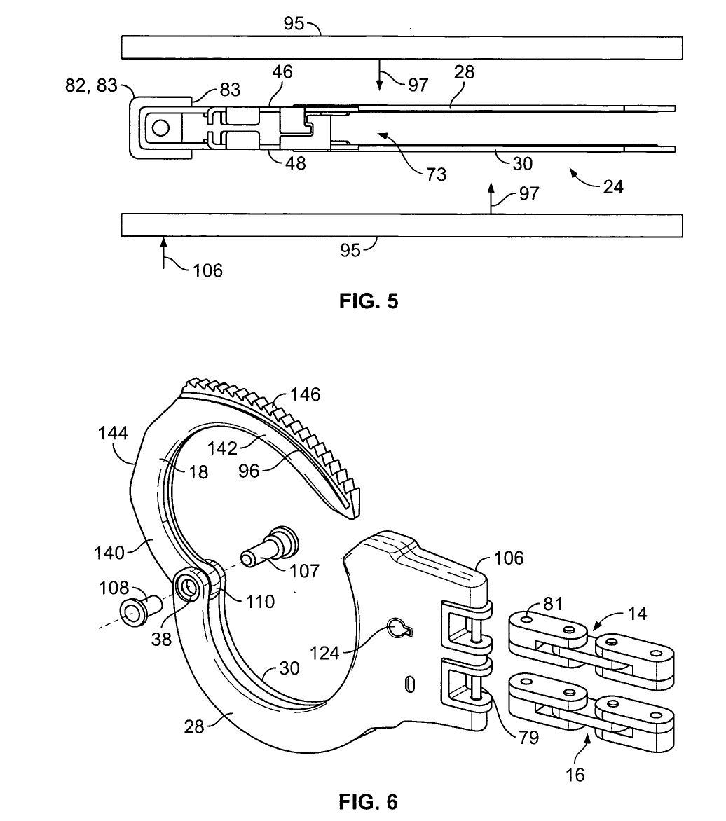

FIG. 2 illustrates a die stamped, stainless steel, metal plate 22 which is folded, bent or formed into a folded cheek plate frame assembly (folded frame) 24 (FIG. 4) including a base frame 26 and parallel spaced cheek arms 28 and 30 as shown in FIGS. 4 and 5.

In the figures, it will be understood that, for the sake of clarity and illustration, in some places the cheek plate frame assembly 24 is illustrated instead of the overmolded cheek plate assembly 20, which is the cheek plate frame assembly having a plastic overmold thereon.

The die stamped plate 22 includes a central base frame forming section 32 and first and second cheek arms or cheek arm plates 28 and 30 which form the cheek plate frame assembly 24 shown in FIGS. 4 and 5. A reinforcing rib 34 or 36 is stamped in each cheek arm plate 28, 30 and a hole 38 or 40 is punched in an outer end 42 or 44 of each cheek arm plate 28, 30 for facilitating pivotal mounting of the bow 18 to and between the cheek arms 28 and 30.

The central base forming section 32 of the die stamped metal plate 22 is specially configured as shown so that when side plates 46 and 48 are folded about phantom lines 50 and 52 to form bottom plate 53, end tabs 54 and 56 are folded inwardly, front tabs 66 and 68 are folded inwardly and hook formations 70 and 72 are folded inwardly, as shown in FIGS. 4 and 5, the unitary base frame 26 is formed with a strong frame interlock 73 formed by the interlocking hook formations 70 and 72.

The base frame forming portion 32 further includes two oval-shaped holes 74 and 75 punched therein which, when portions of the base frame forming portion 32 are folded will form aligned, opposed double-lock slots 74 and 75 for mating with a locksetting slot in a double lock bar in a lockset assembly described in greater detail in U.S. patent Ser. No. 11/361,422 filed on Feb. 23, 2006, assigned to the assignee of the instant invention and incorporated herein by reference.

A set of square center apertures 58, 60 may be stamped into the metal plate 22. The folding of the side plates 46, 48 along fold lines 50, 52 creates a number of support loops 61, 63, 65 that function to support a connection with the connector links 14, 16. After folding, the apertures 58, 60 form a pair of slots or notches 62, 64 (FIG. 4) that receive opposing ends of the connector links 14, 16. The folded junction of the bottom plate 53 and side plates 46, 48A (i.e., the support loops 61, 63, 65) define three sides of an aperture 93 for a retaining (mounting) pin 79 (FIG. 4) that secures the connector links 14, 16 to the base frame 26.

Folding the metal plate 22 along the fold lines 50, 52 creates a cheek plate assembly 20 that is lightweight, yet extremely strong. The folded metal plate 24 forms a continuous, unitary metal plate connection from a pivot point between the bow and first cheek plate 28 on a first end of the plate 22 around the mounting pin 79 (via the support loops 61, 63, 65) and back to the pivot point between the bow and second cheek plate 30 on a second end of the plate 22. The continuous nature of the metal plate connection allows the metal plate 22 to be much thinner and lighter and yet provide far greater strength than conventional riveted handcuff base frames.

A partial keyway defined by openings 84 and 86 are also formed in the die stamped metal plate 22, namely in the side plates 46 and 48 on either side of the bottom plate 53, such that a key can be inserted through either one of these keyway openings 84, 86 from either side of the base frame 26.

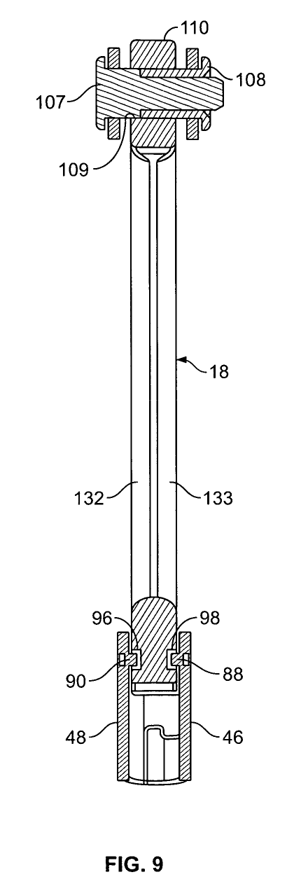

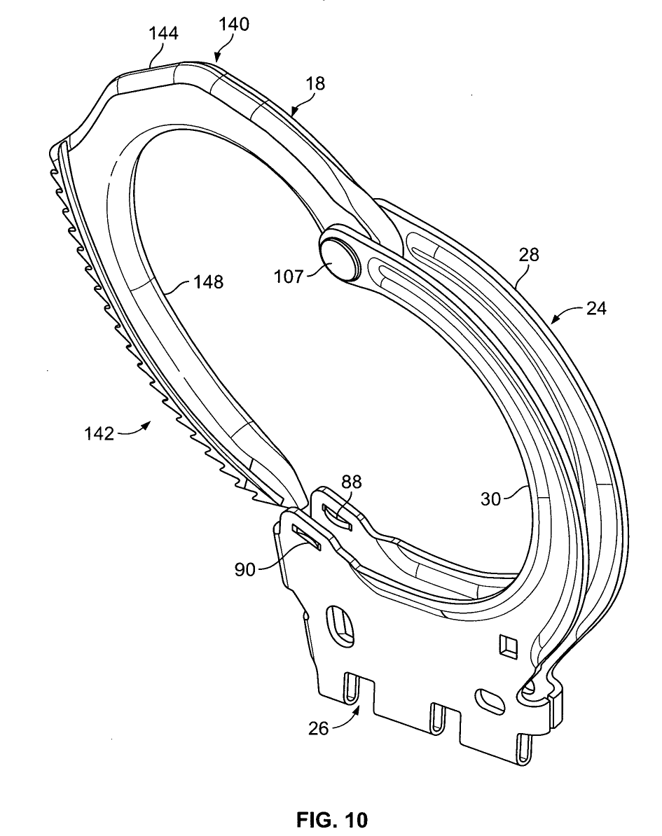

Also, two detents or track guides 88 and 90 are punched into the side plates 46 and 48 adjacent a corner 92 or 94 of the side plate 46 or 48 for being received in a track groove 96 or 98 (FIG. 9) in the bow 18.

Finally, a latch hole or notch 100 is provided in one of the side plates 46, 48, in the illustrated embodiment in side plate 48, for receiving a flexible detent in/on a cover for a housing shell for a housing of the lockset assembly for latching the lockset assembly in the base frame 26 while permitting removal of the lockset assembly from the base frame 26.

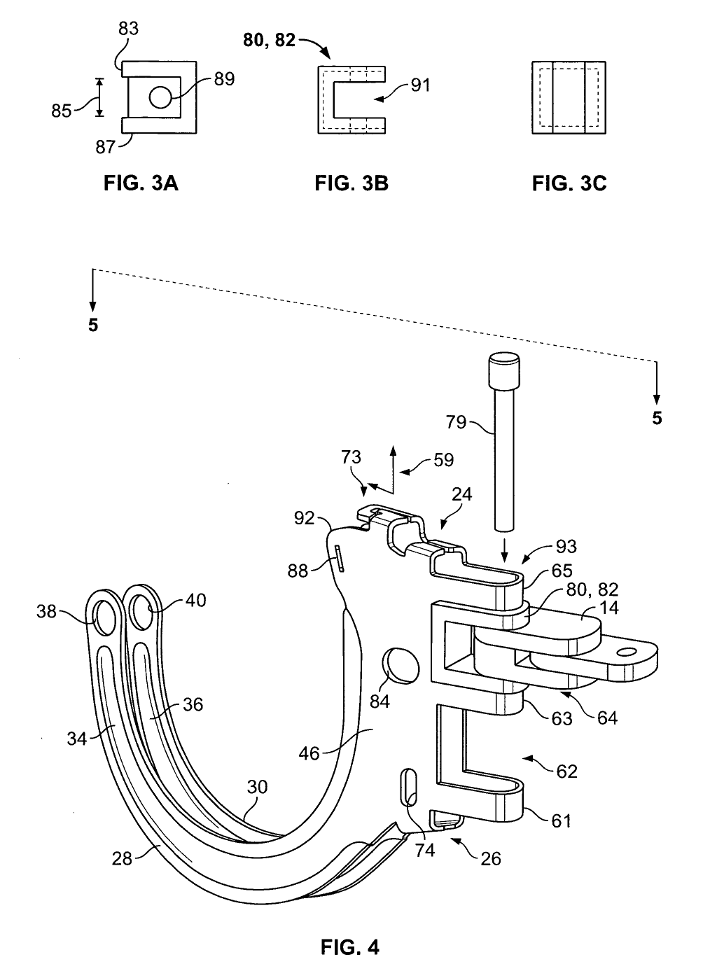

In order to assemble the connector link assemblies 14, 16, a hinge insert 80, 82 (FIG. 3) may first be inserted into each of the slots 62, 64. As shown in FIG. 3, the hinge inserts 80, 82 are U-shaped structures with a dimension 85 intended to be received within the slots 62, 64. A raised area or flange 83, 87 of the hinge insert 80, 82 extends above and outwards over an outer surface of the base frame 26. The flange 83, 87 essentially serves three purposes. One purpose of the flange 83, 87 is to prevent the inserts 80, 82 from extending too far into the slots 62, 64. The flanges 83, 87 stop the inserts 80, 82 from entering the slots 62, 64 any further that what is necessary for the hole 89 to receive the retaining pin 79 through the inside of the support loops 61, 63, 65.

It should be noted that the retaining pin 79 is shown in FIG. 4 as having an enlarged end or head. The enlarged head may be used as a stop to prevent the retaining pin 79 from being inserted too far into the aperture 93. In this case, the enlarged head of the retaining pin 79 would be inserted into the aperture 93 until the head strikes the smaller hole 89 within the insert 80, 82.

In order to better distribute forces within the support loops 61, 63, 65, one or more metallic tubular spacers (not shown) may be inserted onto the retaining pin 79 inside the remaining support loops 63, 65 where the outer diameter of the tubular spacers are equal to the diameter of the head on the retaining pin 79 and the inner diameter of the spacers is substantially equal to a shaft of the retaining pin 79.

The raised outer surface of the flanges 83, 87 also serves a second purpose. The second purpose is to contact and form a seal between the base frame 26 and inserts 80, 82 and between the inserts 80, 82 and an inner surface of a mold. The seal between the base frame 26 and inserts 80, 82 prevents the overmolding material from entering an inside chamber of the base frame 26 that will later be occupied by the lockset assembly. The seal between the flanges 83, 87 prevents overmolding material from entering the area of the hinge connection.

An inside area 91 of the inserts 80, 82 is dimensioned to receive one end of the connector links 14, 16. Once the hinge inserts 80, 82 have been inserted into the slots 62, 62, a first end of the connector link 14 may be inserted into the hinge insert 80, 82 and joined to the base 26 by insertion of the retaining pin 79 as shown in FIG. 4. The retaining pin 79 may be inserted through the aperture 93 in the folded portion, through the holes 89 in the hinge inserts 80, 82 and holes 81 in the connector link assemblies 14, 16.

Once the hinge connection has been assembled, a set of molds 95 may be closed 97 around the frame assembly 24 and an overmolding material may be injected into the mold 95. It should be specifically noted from the partially exploded view of FIG. 6 that the overmold 106 covers opposing ends of the aperture 93 in the folded portion thereby preventing removal of the retaining pin 79 and disassembly and release of the connector link assemblies 14, 16. It should also be noted that since the flanges 83, 87 form a seal between the mold 95 and base frame, the thickness of the overmold is the same as the thickness of the flanges 83, 87, thereby provide a smooth overall surface finish over the base frame.

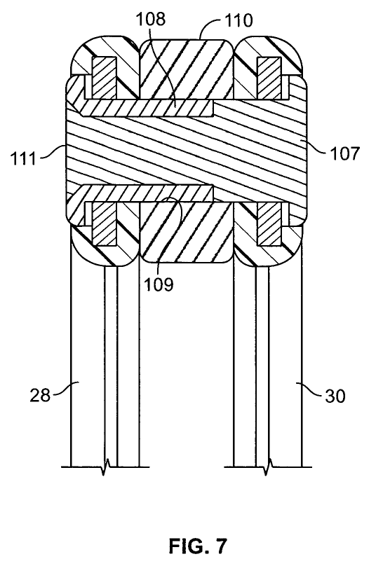

In FIG. 6 is illustrated a perspective view of an open cuff 12 showing a stainless steel pivot pin 107 and a stainless steel pivot bushing 108 positioned for insertion through holes 38 and 40 in the cheek arms 28 and 30 and a hole 109 (FIG. 7) in a base end 110 of the bow 18. The pin 107 is swaged, staked or riveted in place as shown at 111 in FIG. 7.

The cheek arms 28 and 30 are positioned to be parallel spaced from each other as shown. The side plates 46 and 48 and bottom plate 53, as well as the cheek arms 28 and 30 are covered with the plastic overmold 106 to provide the cheek plate assembly 20 with rounded edges and corners. Also the double lock slots 74 and 75 are beveled as a result of the plastic overmold as are keyways 124 and 126 formed in openings 84 and 86 in side plates 46 and 48.

The configuration of the folded frame 24 and plastic overmold allows for the use of a much thinner and lighter handcuffs 10 for a number of reasons. For example, the fold of the folded frame substantially limits the forces within the frame to tensile rather than shear forces. In general, the forces within a set of handcuffs primarily arise from the connection between the handcuffs. In the handcuffs 10, the forces from the connector link assemblies 14, 16 and pin 79 are imparted directly to the support loops 61, 63, 65. Since the folded frame is continuous from the pivot point with the bow around the support loops 61, 63, 65 and back to the pivot point, the forces from the connector link assemblies is primarily tensile.

In contrast, conventional handcuffs are formed by riveting a number of plates together. At least one of the riveted plates must be connected to the connection link between handcuffs while other plates form the cheek plates. The net result is that the rivets of the riveted handcuffs must absorb the forces between the handcuffs as shear forces. The shear forces through the rivets require the plates of riveted handcuffs to be significantly thicker than necessary to avoid pull-through of the rivets.

Further, where the secondary forces within the folded frame 24 are not tensile, the novel features of the handcuff 10 resist the forces in a manner that allows the handcuffs 10 to constructed in a manner that is much lighter that conventional handcuffs. For example, the cheek arms 28, 30 are subjected to a lateral force when a prisoner strains against the handcuffs 10. To resist the lateral forces, the cheek arms 28, 30 have a relatively wide dimension in the plane of rotation of the bow 18. To resist bending in the direction perpendicular to the rotation of the bow 18, the cheek arms 28, 30 are provided with a rib 34, 36 that extends along the cheek arms 34, 36.

While the folded frame 24 allow the handcuffs 10 to be significantly lighter than conventional handcuffs, the minimal dimensions of the frame 24 pose a risk of injury to a prisoner. In order to protect the prisoner, the overmold expands the outside dimensions of the base frame 24 in such a manner as to increase the surface area and, thus, reduce the possibility of injury.

It should be noted, that the plastic overmold 106 enables the cheek plate assembly 20 to have curved, rounded, or beveled edges which will minimize injury to a wrist from the cheek plate assembly 20. Further, the plastic overmolding allows the double-lock slots 74, 75 and the keyway openings 84, 86 to be beveled on each side of the base frame 26.

The bow 18 is preferably formed from stainless steel powder which is sintered. Referring to FIG. 9, the bow 18 includes a first arcuate or curved portion 140 and a second arcuate or curved portion 142 defining a tooth track portion. The first arcuate portion 140 includes the base end 110 with hole 109 therein and has an outer, high contact, flat face 144 which is designed to be applied against the edge of a wrist for pushing the bow 18 through the cheek plate assembly 20 and come full circle about the pivot pin 107 and about a wrist. The second arcuate portion 142 defines a tooth track portion 142 and has spaced, wide, deep set, ratchet teeth 146 formed on an outer side thereof. The tooth track portion 142 is also formed with the arcuate track grooves 96 and 98 on either side thereof.

Further, the bow 18 is polymer infused to inhibit, if not altogether prevent rust or corrosion of the bow 18 and to inhibit, if not to altogether prevent, absorption of body fluids from the wrist of a person being restrained into the bow 18.

Additionally, and according to one of the teachings of the present invention, the envelope formed on an inner edge surface 148 of the bow starting from the base end 110 and extending to the pointed outer end 136 of the bow 18 is formed according to a conic path having an increasing arc so as to form an envelope adapted to receive various sized wrists at different positions of the bow 18 relative to the cheek plates or arms 28, 30 of the cheek plate assembly 20 and with a minimum of pressure applied to the wrist. Stated otherwise the conic path of the surface 148 is a curve generated by a projection of a portion of a conic onto a flat plane.

Again, it will be understood that the envelope of the inner edges of the cheek plate arms 28, 30 going from the outer ends 42 and 44 having the pivot pin mounting holes 38 and 40 to the entry point of the bowl 8 between the corners 92 and 94 of the base frame 26, also follows a similar or the same conic path having an increasing arc.

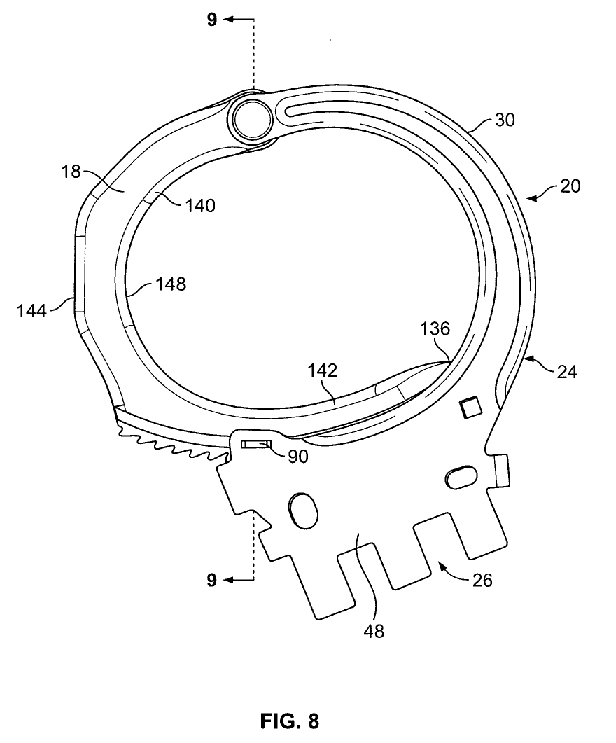

Referring now to FIGS. 8-11, and particularly to FIG. 8, it will be seen that the detents 88 and 90 are located on tangents to a curve of an arc that is generated on a radius between the center of the pivot pin 107 and the center of each detent 88 or 90. As a result, when the bow 18 is rotated counterclockwise in the view of same shown in FIG. 8, the tooth track portion 142 will move smoothly through the cheek plate assembly 20 with the track guides 88, 90 formed by the detents 88, 90 passing through the track groove 96 or 98 on either side of the bow 18.

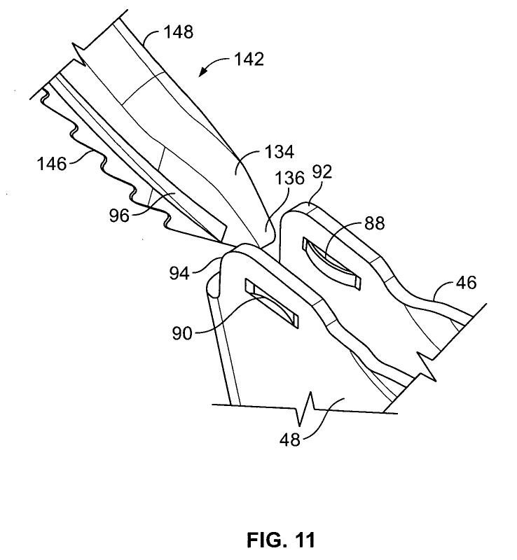

As best shown in FIGS. 10 and 11, the track guides or detents 88, 90 have a rounded configuration for facilitating engagement with the track grooves 96, 98 and facilitate guiding of the bow 18 between the side plates 46 and 48 of the base frame 26 and thereby through and between the cheek plate arms 28 and 30.

In FIGS. 8-11, the unitized frame assembly is shown prior to encapsulation to better illustrate the relationship between the track grooves 96, 98 in the tooth track portion 142 of the bow 18 and the detents or track guides 88, 90. In FIG. 9 it will be seen that the track guide forming detents 88 and 90 are pushed out of the respective side plates 46 and 48 (into the space between the side plates 46 and 48) and form curved rails that have an outer curved surface which are received in the track grooves 96 and 98. Also the rails have a high lateral strength for holding the bow 18 when a test tension force is applied to the handcuff 12 which tends to pull the cheek plates 28, 30 away from the bow in the base frame 26.

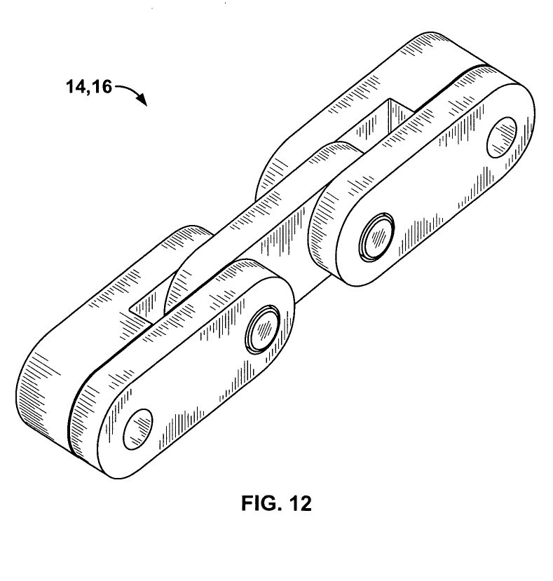

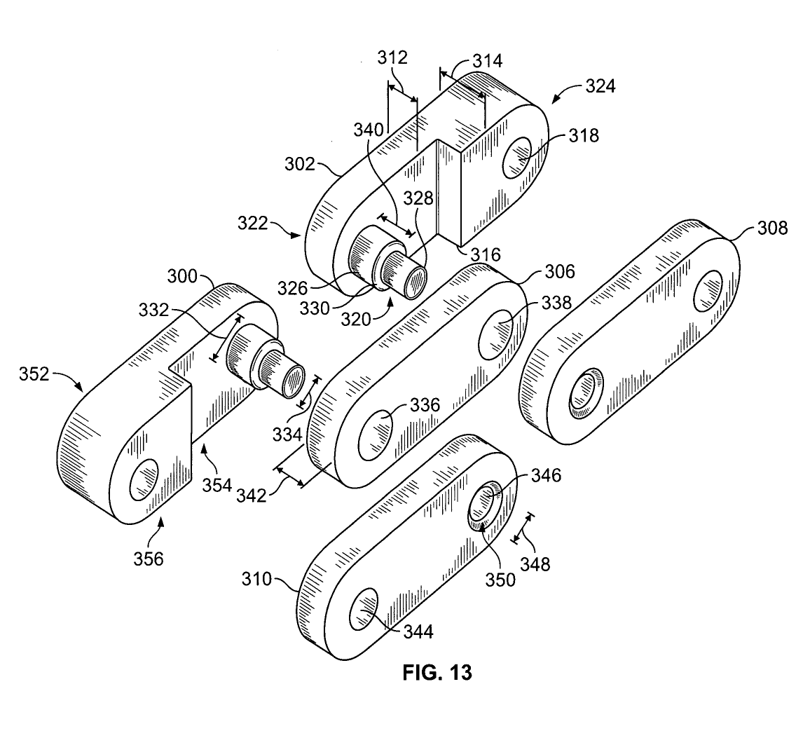

In general, the connector link assemblies 14, 16 of FIG. 12 may be constructed of three basic elements. The three elements include (FIG. 13) a base link 300, 302, a middle link 306 and a cap link 308, 310. As shown in FIG. 12, each connector link assembly 14, 16 includes two base links 300, 302, one middle link 306 and two cap links 308, 310. The base links 300, 302 and cap links 308, 310 are substantially identical.

The elements 300, 302, 304, 306, 308, 310 of each connector link assembly 14, 16 may be constructed using powdered metal (PM) and a powdered metal molding process. As such, each element 300, 302, 304, 306, 308, 310 is a molded link that is hardened by sintering. As used herein, a molded link is a one-piece metal link formed during a single molding operation and is not a composite formed from two or more discrete parts joined by welding, gluing, screws or some other process.

The base links 300, 302 may be fabricated from an appropriate powdered metal (e.g., a duplex stainless steel, part number MS-9707, available from SSI Technologies, Inc. of Janesville Wis.) using a metal injection molding (MIM) process. A 17-20% plastic binder may be added to improve flow during the MIM process.

Following the MIM process the molded base links 300, 302 may be sintered. Sintering may occur at a predetermined temperature (e.g., 2450° F.) and atmosphere (e.g., pure hydrogen) for a predetermined time period (e.g., 90 minutes).

The middle link 306 and cap links 308, 310 may be fabricated from an appropriate powdered metal (e.g., Ultimet 16 Stainless Steel part number MS-9702 available from SSI Technologies, Inc. of Janesville Wis.) using a simple compression molding process. Following molding, the middle link 306 and cap links 308, 310 may be sintered at another predetermined temperature (e.g., 2550° F.) and atmosphere (e.g., pure hydrogen) for a predetermined time period (e.g., 90 minutes).

The base links 300, 302 are rectilinear, generally flat plates (albeit with rounded ends 322, 324) that include a number of generally flat and parallel opposing surfaces, including a back surface 352 and a pair of front surfaces 354, 356. The base links 300, 302 include a first thickness 312 on a first end 322 between the back surface 352 and a first front surface 354 with a step 316 from the first thickness 312 to a second relatively greater thickness 314 on a second end 324 between the back surface 352 and a second front surface 356. The step 316 may lie midway along a length of the base link 300, 302. An aperture 318 extends through the second thickness of the second end 324 between and perpendicular to the back surface 352 and front surface 356.

A post 320 extends from the first end 322 of the base link 300, 302, perpendicular to the surface 354 and parallel to the aperture 318. The post 320 may have a base portion 326 of a first diameter 332 and a distal portion 328 with a second, smaller diameter 334. The step up from the smaller diameter 334 of the distal portion 328 to the diameter 332 of the larger base portion 326 defines a shoulder 330.

The middle link 306 is provided with apertures 336, 338 on opposing ends. The diameter of each aperture 336, 338 is slightly larger (e.g., 0.5 mm) than the diameter 332 of the base portion 326.

In use, the middle link 306 engages the posts 320 on the base links 300, 302. It should be noted in this regard that the length 340 of the base portion 326 is greater than the thickness 342 of the middle link 306. As such, the shoulder 330 of the post 320 extends through a far end of the apertures 336, 338.

The cap links 308, 310 are also provided with apertures 344, 346 on opposing ends. The diameter of the aperture 346 may be comparable in size to or only slightly larger than the diameter 334 of the distal end 328 of the post 320. The aperture 346 on a first end of the cap link 308, 310 is also provided with an expanded terminus 350 of the aperture 346.

When the connector link assemblies 14, 16 are assembled, the middle link 306 engages the posts 320 until the middle link 306 seats against the surface 354 at a base of the post 320. The cap links 308, 210 may then be assembled to the post 320. In this case, since the length 340 of the base portion 326 is greater than the width 342 of the middle link 306, the cap link 308, 310 seats against the shoulder 330. To complete assembly of the connector link assemblies 14, 16, the distal ends of the posts 320 are swaged into the expanded terminus 350 to prevent removal of the cap link 308, 310 from the post 320.

The assembled hinge sets 14, 16 may be assembled to the handcuffs 12 via the pin 79. In this regard, the diameters of apertures 318, 344 are sized to be slightly larger (e.g., 0.5 mm) to allow to pin 79 to easily engage the connector link assemblies 14, 16.

From the foregoing description, it will be understood that the pair of handcuffs 10 of the present invention and the individual handcuffs 12 thereof have a number of advantageous features some of which have been described above and others of which are inherent in the invention. In particular, the set of handcuffs 10 include a bow 18 slightly larger than a prior art bow and arcuate cheek arms slightly larger than prior art cheek arms for engaging wrists of a person to be restrained.

Further, the edges of the actuate cheek arms and of the bow are rounded on the inner surface thereof to minimize trauma to a wrist. The cheek plate assembly is formed from a die stamped metal plate which is folded and bent and includes a frame inner lock as well as reinforcing ribs in the cheek arms which enhance the strength of the cheek plate assembly.

The cheek plate assembly is overmolded with a plastic material to provide rounded edges and beveled edges for keyways and for double lock slots in the cheek plate assembly. The formation of a base frame for the cheek assembly from a die stamp metal plate results in a non-riveted base which is smooth and has a flat profile for placement on a flat surface or on another handcuff.

In general, the bow 18 and cheek plate assembly 20 together lie within (and define) a single predominant plane 59 of each cuff. The connector link assemblies 14, 16 allow movement (rotation) only about an axis that is parallel to the predominant plane of the cuffs. Stated another way, each connector link assembly 14, 16 is only rotates in a plane that is perpendicular to the predominant plane of the cuffs.

Two hinge sets are provided between handcuffs to provide superior strength. Each hinge set includes three link to allow a user to fold the handcuffs 10 over and fit tightly against a user's belt.

Further, it will be understood that the set of handcuffs of the present invention can be modified without departing from the teachings of the invention. Accordingly, the scope of the invention is only to be limited as necessitated by the accompanying claims.

1. A handcuff assembly comprising:
a pair of handcuffs; and
a connector link assembly that joins the pair of handcuffs, said connector link assembly further comprising:
a molded, generally flat base link having a first thickness on a first end, a step on a first side of the base link from the first thickness to a second, relatively greater thickness on a second, opposing end, and an aperture extending through the thickness of the second end, said base link further having a post disposed on the first side and extending from the first end parallel to the aperture, said post having a base portion of a first diameter on a proximal end extending from the first side of the first end to a height substantially equal to the step and a second smaller relative diameter extending from the height of the step to a distal end of the post.

2. The handcuff assembly as in claim 1 wherein the base link further comprises sintered powdered metal.

3. The handcuff assembly as in claim 1 wherein the base link further comprises a metal injection molded base link.

4. The handcuff assembly as in claim 1 wherein the post further comprises a shoulder located between a base and distal end of the post wherein the shoulder defines a dividing line between a diameter of the distal end of the post and a diameter of the base of the post where the base has a larger relative diameter than the distal end.

5. The handcuff assembly as in claim 1 wherein the base link further comprises first and second substantially identical base links.

6. The handcuff assembly as in claim 5 further comprising a middle link that joins the base links, said middle link having apertures on opposing ends that engage the post of the first and second base links, respectively.

7. The handcuff assembly as in claim 6 wherein the middle link further comprises sintered powdered metal.

8. The handcuff assembly as in claim 6 wherein the apertures on opposing ends of the middle link further comprise a diameter that is slightly larger than the shoulder of the post so that the middle link seats against a base of the post.

9. The handcuff assembly as in claim 8 further comprising a cap link with apertures on opposing ends where an aperture on a first end of the opposing ends engages a distal end of the post.

10. The handcuff assembly as in claim 9 wherein the cap link further comprises first and second cap links.

11. The handcuff assembly as in claim 9 wherein the cap link further comprises sintered powdered metal.

12. The handcuff assembly as in claim 9 wherein the aperture on a first end of the cap link is slightly larger than a distal end of the post and slightly smaller than the shoulder, so that a first side of the cap link on the first end seats against the shoulder.

13. The handcuff assembly as in claim 12 wherein the aperture on the first end of the cap link further comprises an expanded entrance on a second opposing side of the cap link.

14. The handcuff assembly as in claim 13 further comprising the distal end of the post swaged into the expanded entrance of the cap link to prevent removal of the cap link from the base link.

15. The handcuff assembly as in claim 8 further comprising a retaining pin that extends through the aperture on a second end of the cap link and a second end of the base link to secure the connector link assembly to a handcuff of the pair of handcuffs.

16. The handcuff assembly as in claim 15 further comprising a folded base frame within a handcuff of the pair of handcuff with a center loop that is engaged by the retaining pin and where opposing ends of the folded base frame engage a bow of the handcuff.

17. A handcuff assembly that includes a pair of handcuffs comprising:
a frame including a plurality of support loops, where the plurality of support loops are formed from a die stamped metal plate that is folded, bent or formed into a folded cheek plate assembly;
a connector link assembly connecting the pair of handcuffs, the connector link extending into a notch between the plurality of support loops of the frame;
a retaining pin that extends through the plurality of support loops of the frame and through an aperture in an end of the connector link to connect the connector link to the frame; and
an overmold that covers opposing ends of the support loops and that prevents removal of the retainer pin from the frame.

18. The handcuff assembly as in claim 17 said connector link assembly further comprises a molded, generally flat base link having a first thickness on a first end, a step on a first side of the base link from the first thickness to a second, relatively greater thickness on a second, opposing end, an aperture extending through the thickness of the second end, said base link further having a post extending from the first end parallel to the aperture on the first side of the base link.

19. The handcuff assembly as in claim 18 wherein the base link further comprises sintered powdered metal.

20. The handcuff assembly as in claim 18 wherein the base link further comprises a metal injection molded base link.

21. The handcuff assembly as in claim 18 wherein the post further comprises a shoulder located between a base and distal end of the post wherein the shoulder defines a dividing line between a diameter of the distal end of the post and a diameter of the base of the post where the base has a larger relative diameter than the distal end.

22. The handcuff assembly as in claim 18 wherein the base link further comprises first and second substantially identical base links.

23. The handcuff assembly as in claim 22 further comprising a middle link that joins the base links, said middle link having apertures on opposing ends that engage the post of the first and second base links, respectively.

24. The handcuff assembly as in claim 23 wherein the middle link further comprises sintered powdered metal.

25. The handcuff assembly as in claim 23 wherein the apertures on opposing ends of the middle link further comprise a diameter that is slightly larger than the shoulder of the post so that the middle link seats against a base of the post.

26. The handcuff assembly as in claim 25 further comprising a cap link with apertures on opposing ends where an aperture on a first end of the opposing ends engages a distal end of the post.

27. The handcuff assembly as in claim 26 wherein the cap link further comprises first and second cap links.

28. The handcuff assembly as in claim 26 wherein the cap link further comprises sintered powdered metal.

29. The handcuff assembly as in claim 26 wherein the aperture on a first end of the cap link is slightly larger than a distal end of the post and slightly smaller than the shoulder, so that a first side of the cap link on the first end seats against the shoulder.

30. The handcuff assembly as in claim 29 wherein the aperture on the first end of the cap link further comprises an expanded entrance on a second opposing side of the cap link.

31. The handcuff assembly as in claim 30 further comprising the distal end of the post swaged into the expanded entrance of the cap link to prevent removal of the cap link from the base link.

32. The handcuff assembly as in claim 31 further comprising a retaining pin that extends through the aperture on a second end of the cap link and a second end of the base link to secure the connector link assembly to a handcuff of the pair of handcuffs.

33. The handcuff assembly as in claim 32 further comprising a folded base frame within a handcuff of the pair of handcuff with a center loop that is engaged by the retaining pin and with opposing ends that engage a bow of the handcuff.
